(19) United States
(12) Patent Application Publication
(10) Pub. No.: US 2008/0280109 A1
(43) Pub. Date: Nov. 13, 2008

(54) Apparatus for re-usable learning card

(76) Inventor: Jennifer Ninan, San Jose, CA (US)

Correspondence Address: The Farrow Law Firm, Suite 500, 3031 Tisch Way, San Jose, CA, 95128, US

(21) Appl. No.: 12/148,064

(22) Filed: Apr. 16, 2008

Related U.S. Application Data
(60) Provisional application No. 60/912,788, filed on Apr. 19, 2007.

(51) Int. Cl. B32B 5/00

(52) U.S. Cl. 428/195.1

(57) ABSTRACT

A learning card system comprised of a rigid backing, an ultra-peelable decal affixed using electrostatic adhesion. Said learning card system being sized to fit in a human hand.

### CLAIM OF PRIORITY

This application claims priority from provisional application 60/912,788 filed on Apr. 19, 2007 and incorporates the same herein in its entirety as is fully set forth hereto.

### BACKGROUND

A decal is a plastic, cloth paper or ceramic substrate that has printed on it a pattern that can be moved to another surface upon contact, usually with the aid of heat or water. This is also known as a transfer. Conversely, when both the pattern and the underlying substrate are transferred to a second surface, the decal is known as a label or sticker. This disclosure is only concerned with decals as label, and not as transfers.

Decals are usually sold with some sort of protective backing to prevent premature adhesion. This backing permits the decal to be removed once without losing any of its adhesive properties. There are many ways in which a decal can achieve adhesion. Some of the common methods include
Pressure sensitive adhesives (also called PSA or self-stick) are applied with light pressure without activation or heat. PSA labels often have release liners which protect the adhesive and assist label handling;
Heat activated adhesives: for example, “in-mold labeling” can be part of blow molding containers and employs heat activated adhesives; and
Wet glue (starch, dextrin, PVA, etc) or water moistenable gummed adhesive.

Pressure sensitive label adhesives are commonly made from water based acrylic adhesives, with a smaller volume made using solvent based adhesives and hot melt adhesives. The most common adhesive types are:
Permanent—Typically not designed to be removed without tearing the stock, damaging the surface, or using solvents. The adhesion strength and speed can also be varied. For example, full adhesion can be nearly instant, or the label can be almost removable for a short period with full adhesion developing in minutes or hours (known as repositionable adhesives).
Peelable—Adhesion is fairly strong and will not fall off in normal circumstances, but the label can be removed relatively easily without tearing the base stock or leaving adhesive behind on the old surface. The adhesive is usually strong enough to be applied again elsewhere.
Ultra-peelable—Designed principally for use on book covers and glass, when removed these adhesives labels do not leave any residue whatsoever. Adhesion is weak and only suitable for light duty applications. Unlike other adhesive methods, ultra-peelable labels often use simple electrostatic attraction to form the adhesive bond.

Decals may be generally permanent, peelable, or ultra-peelable. For example, paper or clear labels sold in office supply stores for affixing to paper are usually peelable from the initial protective barrier, although the adhesive is designed to be removable for a short period of time. Alternatively, labels made of clear acrylic are often designed to be affixed to glass and other materials using only electrostatic attraction. In both cases, decals are usually sold on either 8½ by 11 inch sheets, with a protective backing, for easy imprinting on a laser or inkjet printer, or on circular rolls similar to masking tape for use in a specialty label maker printer.

This protective backing is necessary to permit labels to be stacked on top of each other with them sticking to one another. However, once removed, the protective backing is not designed to re-admit the label. Under both circumstances, once the decal had been removed from the protective backing, the protective backing becomes useless. This creates the limitation that the decals, even the ultra peelable, ones have limited re-usability and transportability.

The new invention admits a means of having a new form factor for the protective backing of ultra-peelable decals such that said decals can be re-affixed to the protective backing a plurality of times.

### Solution

The solution disclosed herein is to create a rigid backing of a size that is easily transportable, combined with an ultra peelable decal affixed through electrostatic adhesion. This is known as the SticKEY Learning card. SticKEY Learning cards are (approximately) 2″×3″ cards made from cardstock, plastic and/or glossy finish material that have a (approximately) 1½″×2¾″ repositionable window decal (that has learning material printed on it) adhered (placed on) to one side of the card. The repositionable window decal on the front of the card can be kept on the card and used as a flash card or it can be placed on mirrors, windows, doors, books, lockers or wherever the window decal will stick.

The SticKEY Learning cards can be used as a set of easily portable flashcards or the user can take the reusable (repositionable) window decal off of the card and place it on and remove it from most surfaces multiple times. SticKEY Learning cards come it topical sets. Additional topical packets can be added to the collection at any time. Specialty sets of SticKEY Learning cards can even be used in the dark, because they are printed with glow in the dark ink.

The small carrying case allows the SticKEY Learning cards to be stored in topic packets and in an easily accessible, convenient way. The decals themselves work by allowing a person to place the small “card” in any location that they chose e.g. on a microwave, refrigerator, mirror, locker, book, car window etc. This mobility of the SticKEY learning card allows people the opportunity to read it more often or study it while performing another activity without having to hold it, or prop it up on a card somewhere.

### DETAILED DESCRIPTION OF THE EMBODIMENTS

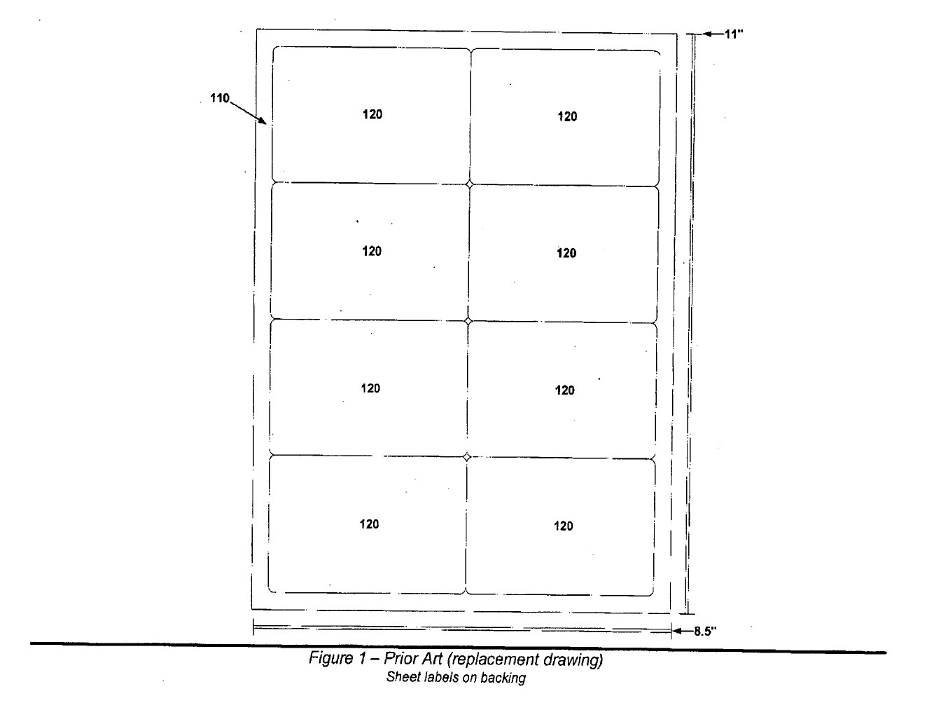

Referring to FIG. 1, FIG. 1 illustrates an example of a traditional sheet of labels, designed primarily for single use applications. Protective Barrier 110 is generally made of a very thin sheet of paper or plastic such that each Label 120 can be easily removed from the protective barrier without damage to either the barrier or Label 120. Label 120 is initially affixed to Protective Barrier 110 with an adhesive chemical such as glue.

Protective Barrier 110 permits sheets of labels to be stacked for storage without the potential of the labels adhering to each other. However, once Label 120 is removed from Protective Barrier 110, it is not designed to be returned to protective Barrier 110, i.e. Protective Barrier 110 is non-reusable.

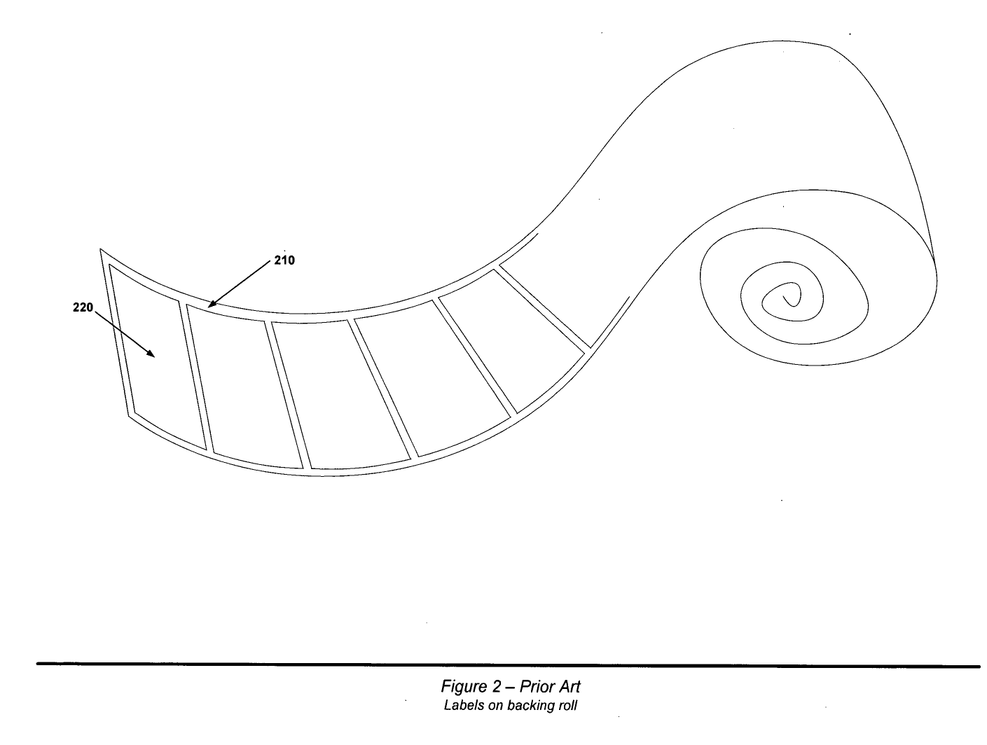

Referring to FIG. 2, FIG. 2 illustrates a roll of labels affixed to a protective backing. Protective Backing 210 is a thin roll of paper or plastic such that each label 220 can be easily removed from the Protective Barrier 210 without damage to either protective Barrier 210 or Label 220. In this embodiment, Protective Barrier 210 permits the labels to be rolled without adhering to each other. Like Protective Barrier 110, Protective Barrier 210 is non-reusable.

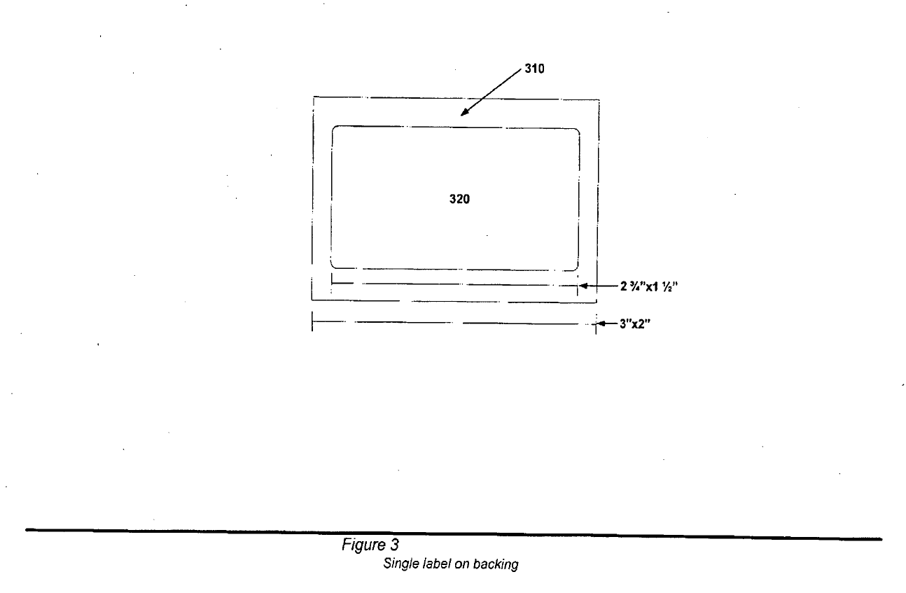

Referring to FIG. 3, FIG. 3 illustrates a first embodiment of the invention, i.e. an exemplary reusable decal with reusable protective barrier. The invention consists of Rigid Backing 310 and Decal 320. Rigid Backing 310 is made of a lightweight material that has electrostatic adhesion on one side, and non-electrostatic adhesion on the other side. Decal 320 is made of any lightweight, flexible material that can be repeatedly affixed to Rigid Backing 310 by electrostatic adhesion.

In the preferred embodiment of the invention, Rigid Back 310 is made from heavy cardstock, plastic, and/or glossy finish material. Rigid Back 310 is of a size that can be easily transported in a shirt pocket, pants pocket, or purse. An ideal size is 2 inches by 3 inches. Decal 320 is ideally made of clear plastic or acrylic having the dimensions 1½ by 2¾ inches.

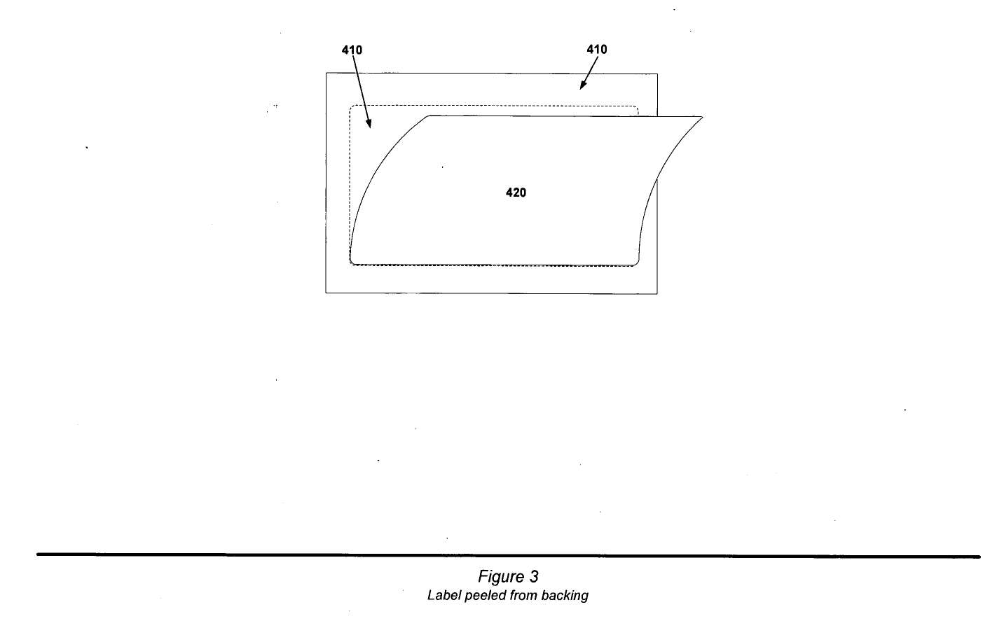

Referring to FIG. 4, FIG. 4 illustrates how that the Decal 420, can be easily peeled from Rigid Back 410. Unlike other peelable labels, Rigid Back 410 does not have any chemical adhesives, thus the exposed potion of Rigid Back 410 is identical to the portion of Rigid Back 410 which is behind Decal 420.

We claim:

1. A SticKEY learning card consisting of a first decal and a first rigid backing; said decal designed to be repeatedly removed and affixed to a rigid backing, said rigid backing being a size and shape convenient to fit into a single hand, said decal being affixed by electrostatic attraction.

2. The decal of claim 1 where the decal is made of paper, plastic, acrylic, or any thin material capable of electrostatic adhesion.

3. The decal of claim 1, where the decal is 2¾ inches by 1½ inches

4. The rigid backing of claim 1 where said rigid backing has a first side capable of electrostatic adhesion.

5. The rigid backing of claim 4, where said rigid backing has a second that is resistant to electrostatic adhesion.

6. The rigid backing of claim 5, where the rigid backing is 3 inches by 2 inches.
